(19) United States
(12) Patent Application Publication
(10) Pub. No.: US 2007/0097324 A1
(43) Pub. Date: May 3, 2007

(54) Image information display unit

(75) Inventors: Tomoyoshi Kikuchi, Musashino-shi (JP); Nobuo Fujimaki, Musashino-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Musashino-shi (JP)

(21) Appl. No.: 11/585,806

(22) Filed: Oct. 25, 2006

(30) Foreign Application Priority Data
Oct. 27, 2005 (JP) 2005-312348

(51) Int. Cl. G03B 21/00

(52) U.S. Cl. 353/46

(57) ABSTRACT

The invention solves a problem in that an operator who puts on a head mount display using a half-mirror can not see image information and a background concurrently because virtual image information is produced at a position of several centimeters before the operator's eyes, thereby allowing fatigue to be accumulated in the operator, and operators who do not put on the head mount display unit can not see image information. The operator puts on a terminal for producing image information, and a projector for projecting image information on an existing structure. Since image information is projected on the structure serving as a background, the operator can see image information and the background naturally and concurrently. Further, operators who do not put on the projector can see image information.

### FIELD OF THE INVENTION

The invention relates to an image information display unit to be put on by a body using a compact projector, in particular, an image information display unit suited to be used by a monitoring person in an industrial plant.

### BACKGROUND OF THE INVENTION

FIG. 4 is a schematic view of a portable monitor to be used when performing maintenance work of various facilities in a site as illustrated in FIG. 4. In the maintenance work, there is a case where a display unit is used for referring to various data, but the work has to be frequently performed by use of both hands, and hence it is difficult to use the display unit on hand.

### SUMMARY OF THE INVENTION

In FIG. 4, depicted by 11 is a personal computer (PC) in which data such as drawings are stored, and which outputs image information indicating the data. Depicted by 12 is a head mount display which is put on by a monitoring person 13 so as to cover an eye of the monitoring person. The head mount display 12 and the PC 11 are connected to each other by a video cable 14, wherein image information outputted from the PC 11 can be displayed on the head mount display 12.

The head mount display 12 has a compact liquid crystal display built therein for displaying image information supplied from the PC 11 via the video cable 14, and projects image information of the compact liquid crystal display on a half mirror by way of an optical unit. It is possible to recognize video of ten several inches as virtual image information at a position of several ten centimeters before the monitoring person's eyes by reflecting light several times in the optical unit. Depicted by 15 is virtual image information.

Further, since the half mirror is used, it is possible to concurrently see the displayed image information of the compact PC and a real scene (background). The monitoring person 13 can confirm conditions of facilities while put on the head mount display 12, and concurrently refers to data stored in the compact PC.

Patent Document 1 discloses a maintenance work support system wherein a monitoring person can efficiently conform working procedures and related books at a site by connecting between a monitoring person terminal, an expert/editor terminal, a designer terminal and a central controller by a network.

According to this maintenance work support system, the monitoring person terminal communicates with the central controller to receive work information, which is subsequently displayed on the monitoring person terminal. Further, a work record received from the monitoring person terminal is sent to the editor terminal to edit the work procedures, so that an expert and a designer can issue an instruction to the monitoring person.

Tools to be put on by a monitoring person are illustrated in FIG. 5. The monitoring person puts on a head mount display unit 21, headphones 22, a microphone 23, a camera 24, a radio communication device 25, and an input device 26. As a result, the monitoring person can transmit conditions of a site to a designer, and an expert, etc., and also can refer to necessary related books.

Patent Document: JP 2004-102727 A

However there were following problems in the head mount display to be used in the portable monitor and the maintenance work support system. As described above, by use of the head mount display, the monitoring person can concurrently see displayed image information of the compact PC and the real background by projecting image information on the half mirror. However, since image information is displayed as if it is positioned at a distance of several ten centimeters before the monitoring person's eyes, if the background is positioned behind the monitoring person by not less than 1 meter, the background is seen as a long-range view while displayed image information is seen as a short-range view, so that it is difficult to see them concurrently. Further, since the long distance view and the short distance view have to be frequently switched over, there created a problem in that the monitoring person accumulates fatigue if the head mount display was used for a long period of time.

Although it was tried that virtual image information is positioned far away by improving an optical system so as to solve these problem, it creates a problem in that an optical lens system becomes complex, resulting in a main cause of the increase of cost of the head mount display.

Since displayed image information and the background are seen only by the monitoring person who puts on the head mount display, there also created a problem in that individual monitoring persons have to put on the head mount display so as to provide information to a plurality of monitoring persons.

### SUMMARY OF THE INVENTION

Accordingly, it is an object of the invention to provide an image information display unit wherein a plurality of monitoring persons can see image information concurrently without resorting to the use of a special optical unit while the monitoring person does not accumulate fatigue.

The image information display unit of the invention is characterized in comprising a portable terminal for producing image information and a projector for projecting image information produced by the portable terminal on an arbitrary object. Accordingly, a person other than the person who puts on the image information display unit can see image information with less fatigue.

The terminal and the projector may be integrated with each other. Accordingly, the image information display unit can be downsized.

The image information display unit may further comprise a portable screen on which image information outputted from the projector is projected. Accordingly, the image information display unit can be used even if there is no object therearound on which image information is projected.

The portable screen may be made of a translucent material through which a part of incident light is transmitted. Accordingly, image information and the background can be seen concurrently.

The projector may have a marker detection section for detecting markers disposed on a screen on which image information is projected, and a projecting method is varied on the basis of information of markers thus detected. Accordingly, it is possible to display image information which is always easily seen even if the person who puts on the image information display unit does not adjust it.

The marker detection section may be used as an input device. Accordingly, the input device is dispensed with.

The terminal may have a GPS receiver built therein, and a position received by the GPS receiver is transmitted to an outside. Accordingly, it is possible to provide data corresponding to a present position of the person who puts on the image information display unit.

The terminal may have an IC tag reader built therein, and may transmit data stored in the IC tag attached to a structure to an outside. Since a present position of the person who puts on the image information display unit is recognized, it is possible to provide data corresponding to the present position of the person who puts on the image information display unit.

The image information display may be further provided with waterproof/explosion-proof function. Accordingly, the image information display unit can be used even in a dangerous area, and so forth.

As is evident from the foregoing description, there are following effects according to the invention. According to the first and ninth aspects of the invention, the terminal for producing image information and the projector for projecting image information on an existing structure and so forth have been put on by the monitoring person.

Since image information can be projected on the structure and so forth, there are effects that image information and the background can be seen concurrently, and the monitoring person does not accumulate fatigue. Further, there is an effect that even a person other than the person who puts on the image information display unit can see image information.

Since the image information display unit is simple in a configuration, there is an effect that it can be downsized, so that an operator can naturally put on the image information display unit. Further, since the image information display unit is provided with the GPS receiver and the IC tag reader, there is another effect that it is possible to provide data corresponding to the present position of an operator.

### BRIEF DESCRIPTION OF THE DRAWINGS

FIG. 1 is a view showing a configuration of an embodiment of the invention;

FIG. 2 is a view for explaining how to use the embodiment of the invention;

FIG. 3 is a view showing a configuration of another embodiment of the invention;

FIG. 4 is a view showing a configuration of a conventional portable monitor; and

FIG. 5 is a view for explaining a conventional maintenance operation support system.

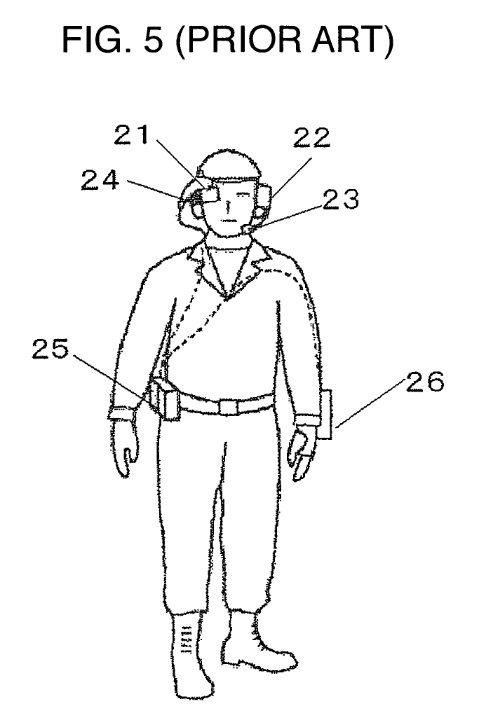

### PREFERRED EMBODIMENT OF THE INVENTION

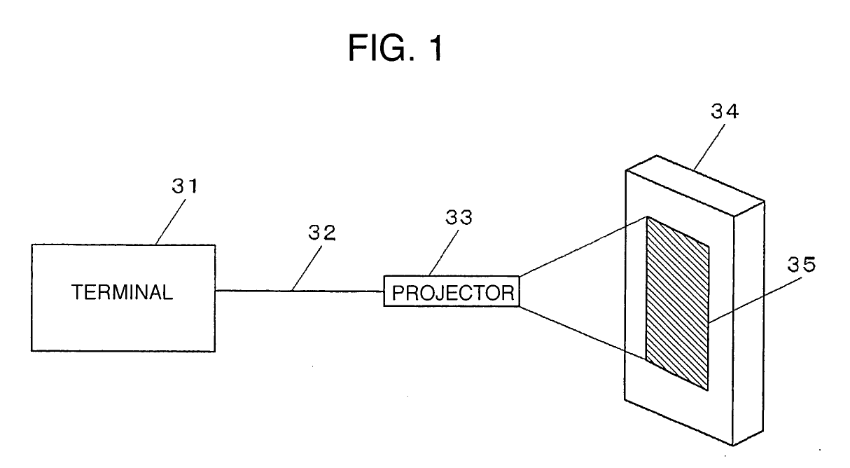

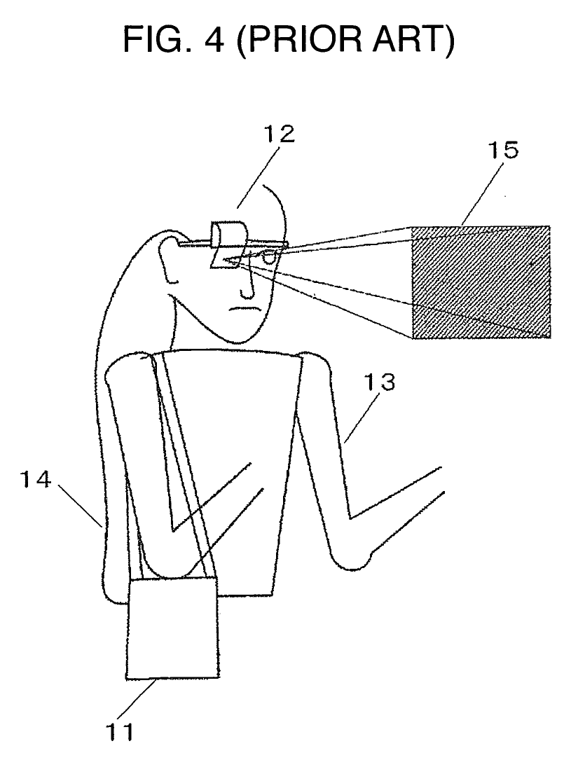

The invention is now described in detail with reference to the accompanying drawings. FIG. 1 is a view showing a configuration of an embodiment of the invention. In FIG. 1, depicted by 31 is a portable terminal, which has the same function as a compact PC shown in FIG. 4, and produces image information. The terminal 31 has a communication section such as a radio communication equipment and obtains image information from a central controller, not shown, and so forth. Alternatively, the terminal 31 may store therein image information that is likely to be used in advance.

Depicted by 33 is a compact projector, which projects and displays image information produced by the terminal 31 on an object. Depicted by 32 is image transmission cable such as an optical fiber, and so forth, which connects the terminal 31 and the image transmission cable 32. Depicted by 34 is a projection screen. The projector 33 projects image information on the projection screen 34. Depicted by 35 is image information projected by the projector 33. The projection screen 34 is not a specific one, and existing walls and flat structures are utilized as the projection screen 34. As the image transmission cable 32 serving as an interface, there may be used radio not a wire cable, The terminal 31 and the projector 33 may be integrated with each other.

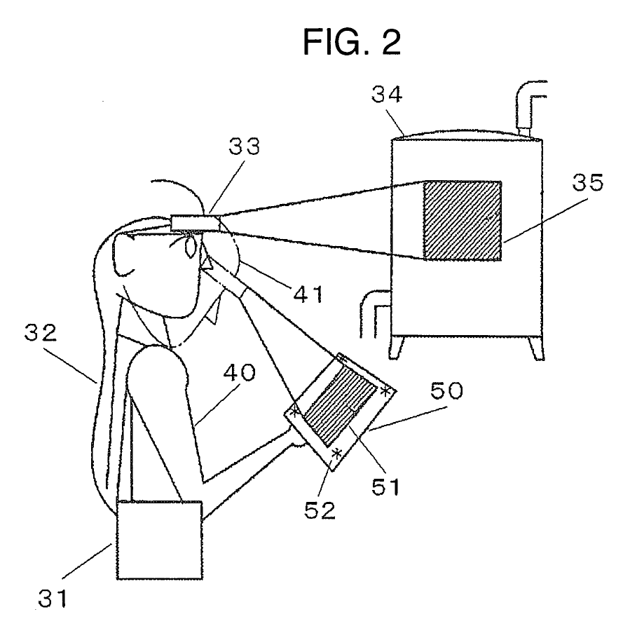

FIG. 2 shows a state where an operator puts on the image information display unit. The components which are the same as those of FIG. 1 are indicated by the same reference numerals, and the explanation thereof is omitted. In FIG. 2, depicted by 40 is a monitoring person who puts the terminal 31 on his or her shoulder and puts the projector 33 on his or her head. As the projection screen 34, a structure like an existing tank is used.

The monitoring person 40 adjusts the inclination of his or her head so that entire image information projected by the projector 33 can be projected on the projection screen 34. Since image information is displayed on the structure per se serving as a background, image information 35 and the background can be seen naturally and concurrently. Not only the monitoring person 40 but also a person who does not put on the projector 33 can see the same image information concurrently.

Depicted by 50 is a portable screen 50 which is carried by the monitoring person 40, and image information can be projected on the portable screen 50. In this case, the monitoring person 40 projects image information on the portable screen 50 while inclining his or her head, as shown by an imaginary line (one dotted chain line) 41. Depicted by 51 is image information thus projected. If the portable screen 50 is made of a translucent material, the monitoring person can see both image information and the background concurrently. Also in this case, a plurality of persons can see image information concurrently.

Depicted by 52 is markers disposed on the portable screen 50 at four corners. The projector 33 has a sensor capable of recognizing the markers 52 and can vary the projecting direction to all directions. The projector 33 is automatically adjusted so that the markers 52 are positioned at four corners of the portable screen 50. As a result, image information can be always displayed on the portable screen 50 even if the monitoring person 40 does not adjust the positions of the projector 33 and the portable screen 50.

Since the terminal 31 can grasp the positional relation between the projector 33 and the portable screen 50 when the sensor recognizes the markers 52, the size, distortion, movement and so forth of image information thus projected can be automatically corrected.

The markers 52 may be provided not only on the portable screen 50 but also on the fixed projection screen 34. By doing so, an optimum image information can be indicated on the projection screen 34 irrespective of the position of the monitoring person 40.

Further, the sensor which recognizes the markers may be used as an input device. That is, different data may be displayed by varying the types and positions of the markers 52, and the types and positions may be recognized by the sensor.

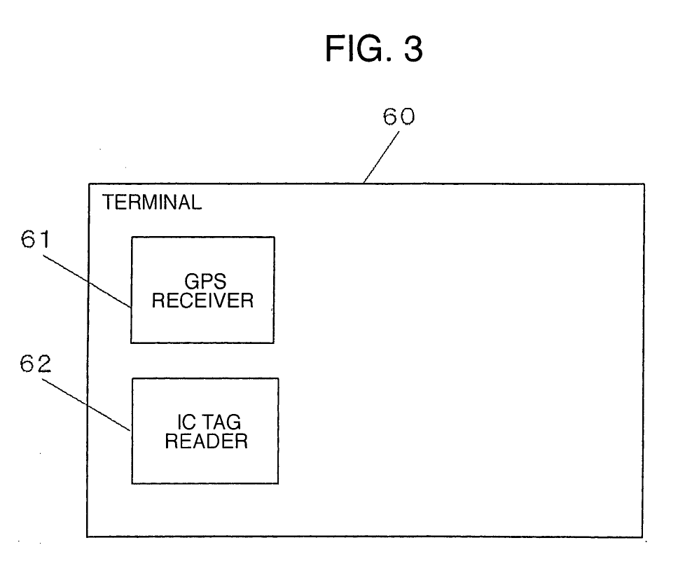

Although the projector 33 is put on by the head of the monitoring person 40 in FIG. 2, it may be put on by other portions such as a waist. If the projector 33 is put on by the head, it may be built in a helmet which render the projector 33 fixed by a hair band to be used like eye-glasses. If the projector 33 is put on by the waist, it FIG. 3 shows another configuration of a terminal. In FIG. 3, depicted by 60 is a portable terminal and produces image information like the terminal 31. Depicted by 61 is a GPS (Global Positioning System) receiver built in the portable terminal 60. The GPS receiver 61 receives radio waves from a satellite, thereby specifying the position thereof. A position and a direction of the monitoring person 40 are specified by the GPS receiver 61, and information thereof is sent in real time to the central controller, not shown. The central controller automatically transmits in real time information corresponding to the position of the monitoring person 40 to the terminal 60.

For example, when the monitoring person 40 approaches a tank, the central controller transmits information such as a water level and a temperature of the tank to the portable terminal 60. The portable terminal 60 converts this information into image information. The monitoring person 40 projects this image information on the tank. By doing so, the conditions of the tank can be more intuitively grasped.

Depicted by 62 is an IC tag reader built in the portable terminal 60, which reads information stored in an IC tag attached to a structure. The portable terminal 60 transmits this IC tag information to the central controller. The central controller transmits information of the structure in which the IC tag is provided to the portable terminal 60. By doing so, it is possible to automatically obtain information even in a place such as an indoor where the GPS receiver 61 can not be used. Both the GPS receiver 61 and the IC tag reader 62 are not always built in the portable terminal 60. Either the GPS receiver 61 or the IC tag reader 62 alone may be built in the portable terminal 60.

Meanwhile, if the terminal 31 and the projector 33 are stored in an airtight container, waterproof/explosion-proof function required by a site-type portable information terminal used in an industrial plant can be fulfilled. Still further, although it is premised that the monitoring person who monitors the industrial plant carries the image information display unit according to the embodiments described above, an operator who operates at a site other than the monitoring person 40 may use the image information display unit.

1. An image information display unit comprising:
a portable terminal for producing image information; a projector for projecting image information produced by the portable terminal on an arbitrary object.

2. An image information display unit according to claim 1, wherein the terminal and the projector are integrated with each other.

3. An image information display unit according to claim 1 or 2, further comprising a portable screen on which image information outputted from the projector is projected.

4. An image information display unit according to claim 3, wherein the portable screen is made of a translucent material through which a part of incident light is transmitted.

5. An image information display unit according to claim 1, the projector has a marker detection section for detecting markers disposed on a screen on which image information is projected, and a projecting method is varied on the basis of information of markers thus detected.

6. An image information display unit according to claim 5, wherein the marker detection section is used as an input device.

7. An image information display unit according to claim 1 or 6, wherein the terminal has a GPS receiver built therein, and a position received by the GPS receiver is transmitted to an outside.

8. An image information display unit according to claim 1, wherein the terminal has an IC tag reader built therein, and transmits data stored in the IC tag attached to a structure to an outside.

9. An image information display unit according to either claim 1 or 8, further provided with waterproof/explosion-proof function.
